(19) United States
(12) Patent Application Publication
(10) Pub. No.: US 2022/0285672 A1
(43) Pub. Date: Sep. 8, 2022

(54) ANODE ACTIVE MATERIAL FOR SECONDARY BATTERY, METHOD OF PREPARING THE SAME AND SECONDARY BATTERY INCLUDING THE SAME

(71) Applicant: SK ON CO., LTD., Seoul (KR)

(72) Inventors: Mi Ryeong LEE, Daejeon (KR); Gi Hyeon MOON, Daejeon (KR); Jong Hyuk LEE, Daejeon (KR); Hee Gyoung KANG, Daejeon (KR)

(21) Appl. No.: 17/683,806

(22) Filed: Mar. 1, 2022

(30) Foreign Application Priority Data
Mar. 8, 2021 (KR) 10-2021-0030295

(51) Int. Cl. H01M 4/36; H01M 4/62

(52) U.S. Cl. CPC H01M 4/366; H01M 4/625; H01M 2004/021

(57) ABSTRACT

An anode active material for a secondary battery according to an embodiment of the present invention includes a core particle, a polymer coating formed on a surface of the core particle, and conductive particles formed on the polymer coating. The conductive particles have an average particle diameter greater than a thickness of the polymer coating. The anode active material and a secondary battery having improved stability and reduced resistance are provided using the polymer coating and the conductive particles.

### CROSS-REFERENCE TO RELATED APPLICATION

This application claims priority to Korean Patent Application No. 10-2021-0030295 filed on Mar. 8, 2021 in the Korean Intellectual Property Office (KIPO), the entire disclosure of which is incorporated by reference herein.

### BACKGROUND

### 1. Field

The present invention relates to an anode active material for a secondary battery, a method of preparing the same, and a secondary battery including the same. More particularly, the present invention relates to an anode active material for a secondary battery including different particles, a method of preparing the same, and a secondary battery including the same.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. The secondary battery includes, e.g., a lithium secondary battery, a nickel-cadmium battery, a nickel-hydrogen battery, etc. The lithium secondary battery is highlighted due to high operational voltage and energy density per unit weight, a high charging rate, a compact dimension, etc.

For example, the lithium secondary battery may include an electrode assembly including a cathode, an anode and a separation layer (separator), and an electrolyte immersing the electrode assembly. The lithium secondary battery may further include an outer case having, e.g., a pouch shape.

For example, the anode may include a carbon-based active material or silicon-based active material particles as an anode active material. When the battery is repeatedly charged/discharged, a side reaction of active material particles may occur due to a contact with the electrolyte, and mechanical and chemical damages such as particle cracks may be caused.

If a composition and a structure of the anode active material are changed to improve stability of the active material particles, a conductivity may be degraded and a power of the secondary battery may be deteriorated.

Thus, developments of the anode active material capable of enhancing life-span stability and power/capacity properties are needed.

For example, Korean Published Patent Application No. 2017-0099748 discloses an electrode assembly for a lithium secondary battery and a lithium secondary battery including the same.

### SUMMARY

According to an aspect of the present invention, there is provided an anode active material for a secondary battery having improved stability and activity.

According to an aspect of the present invention, there is provided a method of preparing an anode active material for a secondary battery having improved stability and activity.

According to an aspect of the present invention, there is provided a secondary battery having improved stability and activity.

An anode active material for a secondary battery according to embodiments of the present invention includes a core particle, a polymer coating formed on a surface of the core particle, and conductive particles formed on the polymer coating. The conductive particles have an average particle diameter greater than a thickness of the polymer coating.

In some embodiments, the core particle may include a graphite-based active material, an amorphous carbon-based material, a silicon-based active material, or a mixture of two or more therefrom.

In some embodiments, the core particle may include artificial graphite.

In some embodiments, the thickness of the polymer coating may be in a range from 1 nm to 100 nm.

In some embodiments, the average particle diameter of the conductive particles may be in a range from 30 nm to 1 μm.

In some embodiments, at least some of the conductive particles may be inserted into the polymer coating and may protrude to an outside from a surface of the polymer coating.

In some embodiments, at least some of the conductive particles may penetrate the polymer coating to contact the core particle.

In some embodiments, the polymer coating may include a polymer having a weight average molecular weight of 50,000 or more and less than 500,000.

In some embodiments, the conductive particles may include lithium titanate (LTO), Super P, carbon black, acetylene black, Ketjen black, carbon flake, activated carbon, graphene, carbon nanotube, carbon nanofiber, a metal fiber, etc. These may be used alone on in a combination thereof

A secondary battery according to embodiments of the present invention includes a cathode including comprising a lithium metal oxide, and an anode facing the cathode. The anode includes the anode active material for a secondary battery according to embodiments as described above.

In a method of preparing an anode active material for a secondary battery according to embodiments of the present invention, a polymer coating is formed on a core particle by a wet coating. A dry surface-treatment is performed on the polymer coating with conductive particles having an average particle diameter greater than a thickness of the polymer coating.

In some embodiments, the wet coating may include agitating the core particle and a solution containing a polymeric material at a first rotational speed. The dry surface-treatment may include agitating the conductive particles with the core particle on which the polymer coating is formed at a second rotational speed. The second rotational speed may be greater than the first rotational speed.

According to exemplary embodiments, a polymer coating may be formed on a core particle, and conductive particles may be formed on the polymer coating or in the polymer coating. Side reactions and damages such as cracks of the core particle providing an anode activity may be prevented, thereby improving life-span stability.

Additionally, paths of electrons or lithium ions may be formed in the polymer coating through the conductive particles, thereby preventing a decrease of power due to the polymer coating and maintaining an sufficient anode activity.

In exemplary embodiments, a diameter of the conductive particles may be greater than a thickness of the polymer coating. Accordingly, electron/ion channels between neighboring anode active material particles may be substantially formed through the conductive particles.

### BRIEF DESCRIPTION OF THE DRAWINGS

FIG. 1 is a schematic cross-sectional view illustrating an anode active material for a secondary battery according to exemplary embodiments.

FIG. 2 is a schematic top planar view illustrating a secondary battery according to exemplary embodiments.

FIG. 3 is a schematic cross-sectional view illustrating a secondary battery according to exemplary embodiments.

FIGS. 4 and 5 are SEM images showing portions of a cross-section of a cathode active material layer from Example obtained for measuring a diameter of conductive particles.

### DETAILED DESCRIPTION OF THE EMBODIMENTS

According to exemplary embodiments of the present invention, an anode active material for a secondary battery that includes a core particle, and a polymer coating and conductive particles formed on the core particle, and a method of preparing the anode active material are provided. Further, a secondary battery including the anode active material is provided.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

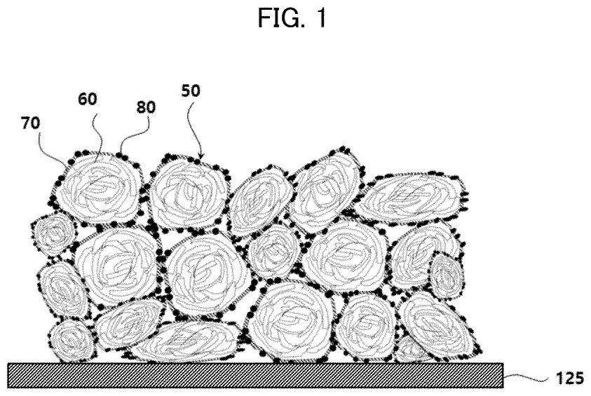

FIG. 1 is a schematic cross-sectional view illustrating an anode active material for a secondary battery according to exemplary embodiments. For example, FIG. 1 schematically illustrate a shape in which anode active materials for a secondary battery are assembled on an anode current collector 125.

Referring to FIG. 1, an anode active material for a secondary battery (hereinafter, which may be abbreviated as an anode active material) 50 may include a core particle 60, a polymer coating 70 and conductive particles 80.

The core particle 60 may serve as a main particle that provides a substantial anode activity. For example, the core particle 60 may include a graphite-based material such as artificial graphite and/or natural graphite.

Preferably, the core particle 60 may include artificial graphite. Artificial graphite may provide a lower capacity than that of natural graphite, but may have relatively high chemical and thermal stability. Accordingly, artificial graphite may be employed as the core particle 60, so that high-temperature storage or high-temperature life-span properties of a secondary battery may be improved. Further, power or capacity properties of the artificial graphite-based core particle 60 may be sufficiently increased by including the conductive particles 80 as will be described below.

In some embodiments, the core particle 60 may include a silicon-based active material. The silicon-based active material may include silicon (Si), SiOx (0<x<2), or a SiOx containing a lithium compound (0<x<2).

The SiOx containing the Li compound may be SiOx containing a lithium silicate. The lithium silicate may be present in at least a portion of a SiOx (0<x<2) particle. For example, the lithium silicate may be present at an inside and/or on a surface of the SiOx (0<x<2) particle. In an embodiment, the lithium silicate may include Li₂SiO₃, Li₂Si₂O₅, Li₄SiO₄, Li₄Si₃O₈, or the like.

In some embodiments, the core particle 60 may include a silicon-carbon-based active material. The silicon-carbon-based active material may include, e.g., silicon carbide (SiC) or a silicon-carbon particle having a core-shell structure.

The silicon-carbon particle may be formed by, e.g., depositing a silicon layer on a surface of a graphite core. In an embodiment, the silicon-carbon particle may be formed by coating a silicon layer on a commercially available graphite particle through a chemical vapor deposition (CVD) process using a silicon precursor compound such as a silane-based compound.

In some embodiments, the core particle 50 may include an amorphous carbon-based material derived from hard carbon, cokes, pitch, or the like. In an embodiment, the core particle 50 may include a mixture of two or more of the aforementioned graphite-based active material, silicon-based active material or amorphous carbon-based material.

An average particle diameter (D₅₀) of the core particles 60 may be from about 1 μm to 100 μm. D₅₀ may refer to a particle diameter at 50% of a volume fraction in a volumetric cumulative particle size distribution. Preferably, the average particle diameter (D₅₀) of the core particle 60 may be from about 5 μm to 20 μm.

The polymer coating 70 may be formed on the surface of the core particle 60. In some embodiments, an outer surface of the core particle 60 may be substantially entirely surrounded by the polymer coating 70. In an embodiment, the polymer coating 70 may be partially formed on the outer surface of the core particle 60. In this case, for example, 50% or more of the outer surface area of the core particle 60 may be covered by the polymer coating 70.

Non-limiting examples of the polymer coating 70 may include polyvinylidene fluoride (polyvinylidenefluoride, PVDF), polyacrylonitrile, polyvinyl alcohol, polyacrylamide, polymethyl methacrylate, polyvinylchloride, etc. These may be used alone or in combination of two or more therefrom.

In some embodiments, a weight average molecular weight (Mw) of a polymer material included in the polymer coating 70 may be less than 500,000. Preferably, the weight average molecular weight (Mw) of the polymer material included in the polymer coating 50 may be in a range from 50,000 to 400,000. Within the above range, sufficient flexibility for inserting the conductive particles 80 may be achieved while suppressing swelling and expansion of the core particle 60 by the polymer coating 70.

The conductive particle 80 may be formed on the polymer coating 70. In exemplary embodiments, an average particle diameter of the conductive particles 80 may be greater than or equal to a thickness of the polymer coating 70. Preferably, the average particle diameter of the conductive particles 80 may be greater than the thickness of the polymer coating 70.

For example, the average particle diameter of the conductive particles 80 may be determined by selecting the predetermined number (e.g., 100 or more) of particles from an SEM cross-sectional image of the anode active material layer 120 formed as will be described below, measuring actual diameters and calculating an average value therefrom

For example, the thickness of the polymer coating 70 may be in a range from about 1 nm to 100 nm, preferably in a range from 10 nm to 100 nm, more preferably in a range from 10 nm to 80 nm. The average particle diameter of the conductive particles 80 may be about in a range from 10 nm to 1 preferably a range from 30 nm to 1 and more preferably a range from 30 nm to 500 nm.

In some embodiments, a ratio of the thickness of the polymer coating 70 relative to the average particle diameter of the conductive particles 80 may be about 0.001 or more. If the ratio is less than 0.001, a uniform protective film formation may not be substantially formed and a sufficient suppression of the side reactions may not be obtained.

The conductive particles 80 may include lithium titanate (LTO), Super P, carbon black, acetylene black, Ketjen black, carbon flake, activated carbon, graphene, carbon nanotube, carbon nanofiber, a metal fiber, or the like. These may be used alone or in a combination of two or more therefrom.

For example, if the conductive particles 80 have a linear structure, the average particle diameter may be measured as a width of the particle, not a length of the particle.

In an embodiment, in the case that a plurality of the conductive particles 80 are agglomerated to form substantially one aggregate, the average particle diameter may refer to an average particle diameter of the aggregate.

In some embodiments, a weight of the conductive particles 80 relative to a total weight of the core particle 60 may be from 0.1 weight percent (wt %) to 5 wt %, preferably from 0.1 wt % to 2 wt %. Within the above range, a sufficient conductive path may be added without inhibiting the anode activity of the core particle 80.

The polymer coating 70 may cover the core particle 60, so that the side reaction, oxidation, corrosion, cracks, etc., at the surface of the core particle 60 may be reduced or prevented. For example, as charging/discharging of the secondary battery is repeated, the surface of the core particle 60 may be mechanically and chemically damaged. Further, while the surface of the core particle 60 is in contact with an electrolyte, a gas generation may be caused by the side reaction.

In exemplary embodiments, the polymer coating 70 may protect the surface of the core particle 60, so that damages and side reactions caused by a direct exposure to the electrolyte may be suppressed. Additionally, the polymer coating 70 may function as an elastic material that may relieve an expansion of the core particle 60. Accordingly, cracks in the particles due to swelling and expansion of the core particle 60 according to repeated charging/discharging may also be suppressed.

In exemplary embodiments, the conductive particles 80 having the particle diameter greater than or equal to the thickness of the polymer coating 70 may be used, so that an increase of resistance and a decrease of power due to the polymer coating 70 may be buffered or compensated.

The conductive particles 80 may have a shape of individual islands formed on the polymer coating 70.

In some embodiments, at least some of the conductive particles 80 may be attached to the surface of the polymer coating 70. In some embodiments, at least some of the conductive particles 80 may be inserted into the polymer coating 70 and protrude to an outside of the polymer coating 70. In some embodiments, at least some of the conductive particles 80 may penetrate the polymer coating 70 and contact the surface of the core particle 60.

The conductive particles 80 may be formed on the polymer coating 70 in the above-described shape, an electron/ion path through the anode active material 50 may be added, and conductivity may be improved. For example, the conductive particles 80 may be exposed from the surface of the polymer coating 70. Accordingly, the conductive particles 80 may be in contact with each other and may serve as a conductor or an ion path between adjacent anode active materials 50, and power/capacity through the anode may be increased.

According to exemplary embodiments, the anode active material 50 may be manufactured according to a method and a process as described below.

For example, the core particles 60 including the above-described graphite-based or silicon-based active material may be prepared. Thereafter, the polymer coating 70 may be formed on the core particle 60.

The polymer coating 70 may be formed by a wet coating method. For example, a solution containing the above-described polymer material may be mixed with the core particles 60, and then agitated at a first rotational speed. Thereafter, the polymer coating 70 may be formed by fixing the polymer material through a heat treatment or a drying.

After the formation of the polymer coating 70, the conductive particles 80 may be formed through a dry surface treatment. For example, the conductive particles 80 may be mixed with the core particle 60 on which the polymer coating 70 is formed, and agitated at a second rotational speed to integrate the conductive particles 80 with the polymer coating 70.

The dry surface treatment may be performed by, e.g., a ball mill, Nobilta mill, mechanofusion, a high-speed mill, or the like.

The second rotational speed may be greater than the first rotational speed. For example, the second rotational speed may be in a range of about 1,000 rpm to 2,000 rpm, and the first rotational speed may be in a range of about 10 ppm to 100 rpm.

Within the above range, the conductive particles 80 may be distributed in individual island patterns without damaging the polymer coating 70 formed as a thin film.

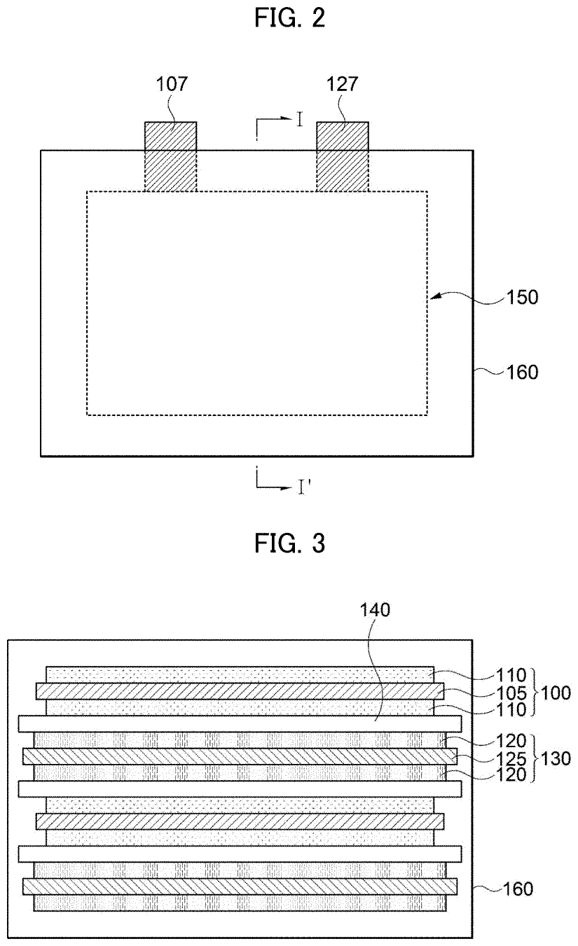

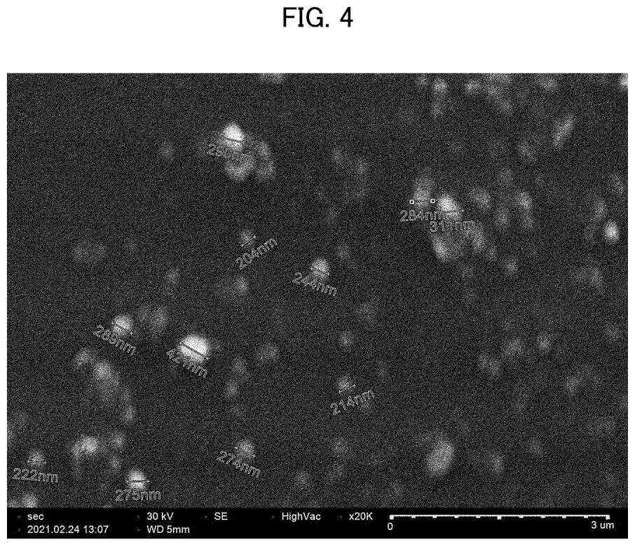

FIGS. 2 and 3 are a schematic top planar view and a schematic cross-sectional view, respectively, illustrating a secondary battery according to exemplary embodiments. For example, FIG. 3 is a cross-sectional view taken along a line I-I′ of FIG. 2 in a thickness direction of the lithium secondary battery.

Referring to FIGS. 2 and 3, the secondary battery may serve as a lithium secondary battery. In exemplary embodiments, the secondary battery may include an electrode assembly 150 and a case 160 accommodating the electrode assembly 150. The electrode assembly 150 may include an anode 100, a cathode 130 and a separation layer 140.

The cathode 100 may include a cathode current collector 105 and a cathode active material layer 110 formed on at least one surface of the cathode current collector 105. In exemplary embodiments, the cathode active material layer 110 may be formed on both surfaces (e.g., upper and lower surfaces) of the cathode current collector 105. For example, the cathode active material layer 110 may be coated on each of the upper and lower surfaces of the cathode current collector 105, and may be directly coated on the surface of the cathode current collector 105.

The cathode current collector 105 may include stainless-steel, nickel, aluminum, titanium, copper or an alloy thereof. Preferably, aluminum or an alloy thereof may be used.

The cathode active material layer 110 may include a lithium metal oxide as a cathode active material. In exemplary embodiments, the cathode active material may include a lithium (Li)-nickel (Ni)-based oxide.

In some embodiments, the lithium metal oxide included in the cathode active material layer 110 may be represented by Chemical Formula 1 below.

Li₁₊ₐNi_{1-(x+y)}CoₓM_{y}O₂ [Chemical Formula 1]

In the Chemical Formula 1 above, −0.05≤a≤0.15, 0.01≤x≤0.2, 0≤y≤0.2, and M may include at least one element selected from Mn, Mg, Sr, Ba, B, Al, Si, Ti, Zr and W. In an embodiment, 0.01≤x≤0.20, 0.01≤y≤0.15 in Chemical Formula 1.

Preferably, in Chemical Formula 1, M may be manganese (Mn). In this case, nickel-cobalt-manganese (NCM)-based lithium oxide may be used as the cathode active material.

For example, nickel (Ni) may serve as a metal related to a capacity of a lithium secondary battery. As the content of nickel increases, capacity of the lithium secondary battery may be improved. However, if the content of nickel is excessively increased, life-span may be decreased, and mechanical and electrical stability may be degraded.

For example, cobalt (Co) may serve as a metal related to conductivity or resistance, and power of the lithium secondary battery. In an embodiment, M may include manganese (Mn), and Mn may serve as a metal related to mechanical and electrical stability of the lithium secondary battery.

Power, low resistance and life-span stability may be improved together from the cathode active material layer 110 by the above-described interaction between nickel, cobalt and manganese.

For example, a slurry may be prepared by mixing and stirring the cathode active material with a binder, a conductive material and/or a dispersive agent in a solvent. The slurry may be coated on the cathode current collector 105, and then dried and pressed to form the cathode active material layer 110.

The binder may include an organic based binder such as a polyvinylidene fluoride-hexafluoropropylene copolymer (PVDF-co-HFP), polyvinylidenefluoride (PVDF), polyacrylonitrile, polymethylmethacrylate, etc., or an aqueous based binder such as styrene-butadiene rubber (SBR) that may be used with a thickener such as carboxymethyl cellulose (CMC).

For example, a PVDF-based binder may be used as a cathode binder. In this case, an amount of the binder for forming the cathode active material layer 110 may be reduced, and an amount of the cathode active material or lithium metal oxide particles may be relatively increased. Thus, capacity and power of the lithium secondary battery may be further improved.

The conductive material may be added to facilitate electron mobility between active material particles. For example, the conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

In some embodiments, an electrode density of the cathode 100 may be in a range from 3.0 g/cc to 3.9 g/cc, preferably from 3.2 g/cc to 3.8 g/cc.

The anode 130 may include an anode current collector 125 and an anode active material layer 120 formed on at least one surface of the anode current collector 125. In exemplary embodiments, the anode active material layer 120 may be formed on both surfaces (e.g., upper and lower surfaces) of the anode current collector 125. The anode active material layer 120 may be coated on each of the upper and lower surfaces of the anode current collector 125. For example, the anode active material layer 120 may directly contact the surface of the anode current collector 125.

The anode current collector 125 may include gold, stainless steel, nickel, aluminum, titanium, copper, or an alloy thereof, preferably may include copper or a copper alloy.

In exemplary embodiments, the anode active material layer 120 may include the anode active material 50 according to the above-described exemplary embodiments. For example, the anode active material 50 may be included in an amount ranging from 80 wt % to 99 wt % based on a total weight of the anode active material layer 120. Preferably, the amount of the anode active material may be in a arrange from 90 wt % to 98 wt % based on the total weight of the anode active material layer 120.

For example, an anode slurry may be prepared by mixing and stirring the anode active material 50 with a binder, a conductive material and/or a dispersive agent in a solvent. The anode slurry may be applied (coated) on the anode current collector 125, and then dried and pressed to form the anode active material layer 120.

The binder and the conductive material substantially the same as or similar to those used for forming the cathode 100 may be used in the anode 130. In some embodiments, the binder for forming the anode 130 may include, e.g., styrene-butadiene rubber (SBR) or an acrylic binder for compatibility with the graphite-based active material, and carboxymethyl cellulose (CMC) may also be used as a thickener.

In exemplary embodiments, an electrode density of the anode active material layer 120 may be 1.4 g/cc to 1.9 g/cc.

In some embodiments, an area and/or a volume of the anode 130 (e.g., a contact area with the separation layer 140) may be greater than that of the cathode 100. Thus, lithium ions generated from the cathode 100 may be easily transferred to the anode 130 without a loss by, e.g., precipitation or sedimentation to further improve power and capacity of the secondary battery.

The separation layer 140 may be interposed between the cathode 100 and the anode 130. The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 140 may also include a non-woven fabric formed from a glass fiber with a high melting point, a polyethylene terephthalate fiber, or the like.

The separation 140 may extend in a width direction of the secondary battery between the cathode 100 and the anode 130, and may be folded and wound along the thickness direction of the lithium secondary battery. Accordingly, a plurality of the anodes 100 and the cathodes 130 may be stacked in the thickness direction using the separation layer 140.

In exemplary embodiments, an electrode cell may be defined by the cathode 100, the anode 130 and the separation layer 140, and a plurality of the electrode cells may be stacked to form the electrode assembly 150 that may have e.g., a jelly roll shape. For example, the electrode assembly 150 may be formed by winding, laminating or folding the separation layer 140.

The electrode assembly 150 may be accommodated together with an electrolyte in the case 160 to define the lithium secondary battery. The case 160 may include, e.g., a pouch, a can, etc.

In exemplary embodiments, a non-aqueous electrolyte may be used as the electrolyte.

The non-aqueous electrolyte solution may include a lithium salt and an organic solvent. The lithium salt may be represented by Li⁺X⁻, and an anion of the lithium salt X⁻ may include, e.g., F⁻, Cl⁻, Br⁻, I⁻, NO₃⁻, N(CN)₂⁻, BF⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N, (FSO₂)₂N⁻, CF₃CF₂(CF₃)₂CO⁻, (CF₃SO₂)₂CH⁻, (SF₅)₃C⁻, (CF₃SO₂)₃C″, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination of two or more therefrom.

As illustrated in FIG. 2, electrode tabs (a cathode tab and an anode tab) may protrude from the cathode current collector 105 and the anode current collector 125 included in each electrode cell to one side of the case 160. The electrode tabs may be welded together with the one side of the case 160 to be connected to an electrode lead (a cathode lead 107 and an anode lead 127) that may be extended or exposed to an outside of the case 160.

FIG. 2 illustrates that the cathode lead 107 and the anode lead 127 are positioned at the same side of the lithium secondary battery or the case 160, but the cathode lead 107 and the anode lead 127 may be formed at opposite sides to each other.

For example, the cathode lead 107 may be formed at one side of the case 160, and the anode lead 127 may be formed at the other side of the case 160.

The lithium secondary battery may be manufactured in, e.g., a cylindrical shape using a can, a square shape, a pouch shape or a coin shape.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### EXAMPLE

100 g of artificial graphite (D₅₀: 10 μm) and 37.5 g of 1.5% aqueous solution of polyvinyl alcohol (PVA) (Mw: about 180,000) were put into a mixer (manufactured by INOUE), mixed at a stirring speed of 20 Hz for 2 hours, and then dried at 60° C. under a vacuum condition.

Super P (average particle diameter: 255 nm) was added to an artificial graphite active material including a PVA coating (a coating thickness: 50 nm) formed thereon in an amount of 0.5 wt % based on a weight of artificial graphite, and a high-speed surface treatment was performed for 10 minutes at a stirring speed of 1100 rpm using a Nobilta mill.

The anode active material as prepared above, CMC and SBR were mixed in a weight ratio of 97.3:1.2:1.5 to prepare an anode slurry. The anode slurry was coated on a Cu foil, dried and pressed to prepare an anode having mixture densities of 7 mg/cm² and 1.6 g/cc.

A coin cell-type secondary battery was fabricated using a Li foil as a counter electrode and an 1M LiPF₆ solution in a mixed solvent (EC:EMC=3:7) as an electrolyte.

The average particle diameter of the conductive particles (Super P) was calculated as an average value after selecting 100 particles from SEM cross-sectional image of the anode active material layer and measuring particle diameters of each particle.

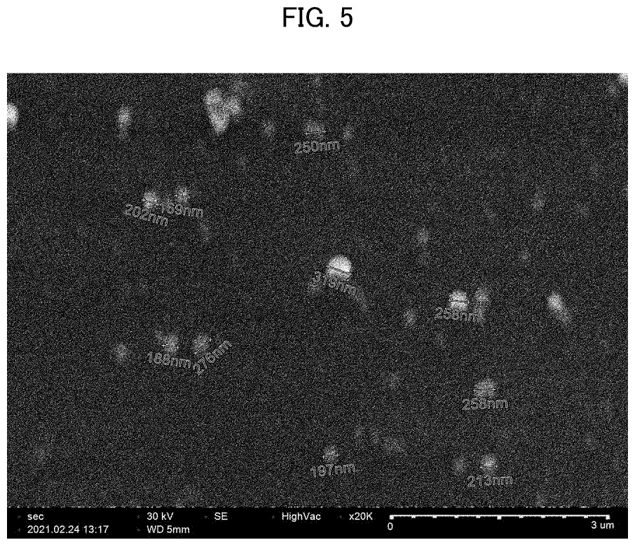

FIGS. 4 and 5 are SEM images showing portions of a cross-section of a cathode active material layer from Example obtained for measuring a diameter of conductive particles. FIGS. 4 and 5 show some of the actually measured conductive particles.

### Comparative Example 1

A secondary battery was fabricated by the same method as that in Example, except that artificial graphite in which the PVA coating and the addition of Super P were omitted was used as the anode active material.

### Comparative Example 2

A secondary battery was fabricated by the same method as that in Example, except that artificial graphite in which the PVA coating was included and the addition of Super P was omitted was used as the anode active material.

### Comparative Example 3

A secondary battery was fabricated by the same method as that in Example, except that a thickness of the PVA coating was 300 nm.

### Experimental Example

(1) Initial Efficiency Evaluation

While repeating charging and discharging the secondary batteries of Example and Comparative Examples at high rate conditions in an order of 0.1C, 0.2C, 0.5C, 1.0C, 1.5C, 2.0C, 3.0C, 4.0C and 5.0C (total 45 cycles), a discharge capacity of each cycle was measured. Thereafter, while repeating charging and discharging the secondary batteries at a low rate condition of 0.1C, a discharge capacity at the 60th cycle was measured. An initial efficiency was measured as a percentage of the discharge capacity at the 60th cycle relative to a discharge capacity at the 1st cycle.

(2) Measurement of Resistance Efficiency

Charging (CCCV, 4.2V, 0.05C cut-off)-discharging (CC, 2.5V cut-off) as one cycle was performed at 25° C., and 200 cycles of the charging-discharging were repeated.

A resistance efficiency was measured as a percentage of a resistance at 10 seconds of discharge by SOC50% after the 200th cycle relative to a resistance at 10 seconds of discharge by SOC50% after the 1st cycle.

The results are shown in Table 1 below.

TABLE 1

| No. | Initial Efficiency | Resistance Efficiency |
|---|---|---|
| Example | 89.4% | 99% |
| Comparative Example 1 | 88.9% | 105% |
| Comparative Example 2 | 88.2% | 140% |
| Comparative Example 3 | 88.4% | 130% |

Referring to Table 1, the secondary battery of Example where the anode active material included the polymer coating and the conductive particles having a greater diameter than a thickness of the polymer coating provided improved initial efficiency and reduced resistance.

What is claimed is:

1. An anode active material for a secondary battery, comprising:
a core particle;
a polymer coating formed on a surface of the core particle; and
conductive particles formed on the polymer coating, the conductive particles having an average particle diameter greater than a thickness of the polymer coating.

2. The anode active material for a secondary battery of claim 1, wherein the core particle comprises a graphite-based active material, an amorphous carbon-based material, a silicon-based active material, or a mixture of two or more therefrom.

3. The anode active material for a secondary battery of claim 1, wherein the core particle comprises artificial graphite.

4. The anode active material for a secondary battery of claim 1, wherein the thickness of the polymer coating is in a range from 1 nm to 100 nm.

5. The anode active material for a secondary battery of claim 1, wherein the average particle diameter of the conductive particles is in a range from 30 nm to 1 μm.

6. The anode active material for a secondary battery of claim 1, wherein at least some of the conductive particles are inserted into the polymer coating and protrude to an outside from a surface of the polymer coating.

7. The anode active material for a secondary battery of claim 1, wherein at least some of the conductive particles penetrate the polymer coating to contact the core particle.

8. The anode active material for a secondary battery of claim 1, wherein the polymer coating comprises a polymer having a weight average molecular weight of 50,000 or more and less than 500,000.

9. The anode active material for a secondary battery of claim 1, wherein the conductive particles comprise at least one selected from the group consisting of lithium titanate (LTO), Super P, carbon black, acetylene black, Ketjen black, carbon flake, activated carbon, graphene, carbon nanotube, carbon nanofiber and a metal fiber.

10. A secondary battery, comprising:
a cathode comprising a lithium metal oxide; and
an anode facing the cathode, the anode comprising the anode active material for a secondary battery according to claim 1.

11. A method of preparing an anode active material for a secondary battery, comprising:
forming a polymer coating on a core particle by a wet coating; and
performing a dry surface-treatment on the polymer coating with conductive particles having an average particle diameter greater than a thickness of the polymer coating.

12. The method of claim 11, wherein the wet coating comprises agitating the core particle and a solution containing a polymeric material at a first rotational speed;
the dry surface-treatment comprises agitating the conductive particles with the core particle on which the polymer coating is formed at a second rotational speed; and
the second rotational speed is greater than the first rotational speed.
